(19) United States
(12) Patent Application Publication
(10) Pub. No.: US 2018/0227321 A1
(43) Pub. Date: Aug. 9, 2018

(54) REPUTATION SCORE FOR NEWLY OBSERVED DOMAIN

(71) Applicant: International Business Machines Corporation, Armonk, NY (US)

(72) Inventors: ALON FREUND, Maale Adumin (IL); YOSSI GILAD, Tel-Mond (IL); ODED MARGALIT, Ramat Gan (IL); AVIV RON, Klachim (IL)

(21) Appl. No.: 15/397,782

(22) Filed: Feb. 5, 2017

(51) Int. Cl. H04L 29/06; G06N 99/00

(52) U.S. Cl. CPC H04L 63/1425; G06N 99/005

(57) ABSTRACT

A method and system for calculating and ascribing reputation scores to Domain Name System (DNS) domain names, the method including capturing domain names appearing in a network during a predefined time frame and extracting features of each of the captured domain names, and calculating a reputation score for each of the captured domain names by assessing an expected life duration of each of the captured domain names based on the domain name features.

### BACKGROUND

The present invention, in some embodiments thereof, relates to detection of domain names used for malicious activities and, more specifically, but not exclusively, to calculation of reputation values of domain names.

Some systems decide on how to act upon a domain name based on a reputation value assigned the encountered domain name.

In order to provide reputation values, some methods use large quantity of manually classified domains in order to train a classifier. In order to update the classifier, a new quantity of domains needs to be manually classified, which makes the classifier rigid and hard to adapt.

Some other methods analyses the content of each domain. The time and resources required by these methods may not be available when a quick and resource-efficient detection of malicious domain names is required.

### SUMMARY

According to an aspect of some embodiments of the present invention there is provided a system for calculating and ascribing reputation scores to Domain Name System (DNS) domain names, the system including: a memory storing a code; and at least one hardware processor coupled to the memory for executing the code, the code including: instructions for capturing domain names appearing in a network during a predefined time frame and extracting features of each of the captured domain names; and instructions for calculating a reputation score for each of the captured domain names by assessing an expected life duration of each of the captured domain names based on the domain name features.

Optionally, the code further includes instructions to intercept network messages during the predefined time frame and to capture domain names by identifying domain names in the intercepted messages.

Optionally, the code further includes instructions to assign an initial reputation score for each of the captured domain names, and instructions to increase the reputation score of a domain name every predetermined time interval in case the domain name is still reachable.

Optionally, the instructions for calculating a reputation score include determining based on the life duration a measure in which the reputation score of a domain name increases in each time interval.

Optionally, the determining is based on a probability that a captured domain name would remain reachable after a certain time period.

Optionally, the domain name features include at least one of a list including top level domain (TLD), registrar, list of DNS record types, geographic location of hosting servers, geographic location of name servers, number of name servers, ASN details, similarity of parts of the domain name to popular brands, the length of the domain name and length of its tokens.

Optionally, the code further includes instructions for training a classifier to assess expected life duration of a domain name based on features of the domain name.

Optionally, the classifier constitutes of a weighted function of domain name features.

Optionally, the instructions for training a classifier to assess an expected life duration include at least one of instructions to train a classifier to assess whether a captured domain name would remain reachable after a certain time period and instructions to train a classifier to assess a probability that a captured domain name would remain reachable after a certain time period.

Optionally, the certain time period is one of a predefined series of time period values, and wherein the instructions to train a classifier are for assessing the longest time period of the series of time period values after which the domain name would remain reachable.

Optionally, the instructions to train a classifier are for determining a time period value of the series of time period values as the longest time period in case an assessed probability that the domain would remain reachable after the time period value is above a predetermined threshold.

Optionally, the code includes instructions for updating the classifier and repeating calculating of a reputation score once the classifier is updated.

Optionally, the updating of the classifier includes shifting the time frame.

Optionally, the calculation of reputation score is repeated for domain names having a reputation score below a predetermined threshold.

Optionally, the training of a classifier includes training the classifier to identify the effect of each domain name feature on whether a domain name would still be active after a predefined period of time.

Optionally, the training of a classifier includes training the classifier to calculate a class value reflecting the length of a time duration after which the domain name would still be active by combining the effect of each of the extracted features on the time duration.

Optionally, the training of a classifier includes training the classifier to map each domain name into a multi-dimensional space of features, wherein each feature affects the probability of a domain name to remain active after a predetermined time, and to calculate a class value based on the location of the domain name in the multi-dimensional space of features.

According to an aspect of some embodiments of the present invention there is provided a method for calculating and ascribing reputation scores to DNS domain names, the method including: capturing domain names appearing in a network during a predefined time frame and extracting features of each of the captured domain names; and calculating a reputation score for each of the captured domain names by assessing an expected life duration of each of the captured domain names based on the domain name features.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic flowchart illustrating a method for calculating and ascribing reputation scores for internet domain names, according to some embodiments of the present invention;

FIG. 2 is a schematic illustration of a Domain Name System (DNS) monitor system according to some embodiments of the present invention;

FIG. 3 is a schematic flowchart illustrating a method for training a classifier for assessing expected life duration of new domains, according to some embodiments of the present invention; and

FIG. 4 is a schematic illustration of a shifted timeframe for updating a classifier according to some embodiments of the present invention.

### DETAILED DESCRIPTION

Since new internet domains have no history to study and analyze, current methods have difficulties in assessing their credibility. Some embodiments of the present invention provide systems and methods for assigning a reputation score to new domain names shortly after their first appearance.

A scoring method and system according to some embodiments of the present invention gives higher reputation scores to domain names that remain active longer, based on an assumption that malicious domains are active for a relatively short time. Therefore, after assigning of a reputation score to a domain name, the system iteratively improves the reputation score such that the score increases as the domain name continues to be active.

For example, appearances of new domain names are detected in network messages during a determined period of time, and the system checks which of the domain names remain active after a determined period of time. Then, properties of the domain names that remained active are analyzed.

The system builds and/or trains a classifier based on the properties of the remaining domain names, for example a classifier identifying properties of credible domain names. The classifier may be used by the system for evaluating a life expectancy of a new domain name, and for calculating a credibility score, the score being a function of evaluated life expectancy. Life expectancy or expected life duration of a domain is the expected time during which the domain name would remain active.

For example, the classifier may analyze features of a domain name and compute a combined class value based on a learned influence of each feature on the class value. The class value may be indicative of the expected life duration, for example of a probability that a domain name would remain active after a certain time period. Based on the class value, the system decides on an increasing measure of a reputation score ascribed to the domain name. As long as the domain name actually remains active, its reputation score increases by the decided increasing measure, for example every predefined time interval such as about a second or a few seconds.

Therefore, by building and using the classifier based on properties of appearing domain names, a credibility of a new appearing domain name may be evaluated shortly after its appearance. Such technical solution is required for quickly identifying malicious domains, which may attack a short time after their appearance and therefore, a delayed identification may be too late for preventing an attack.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

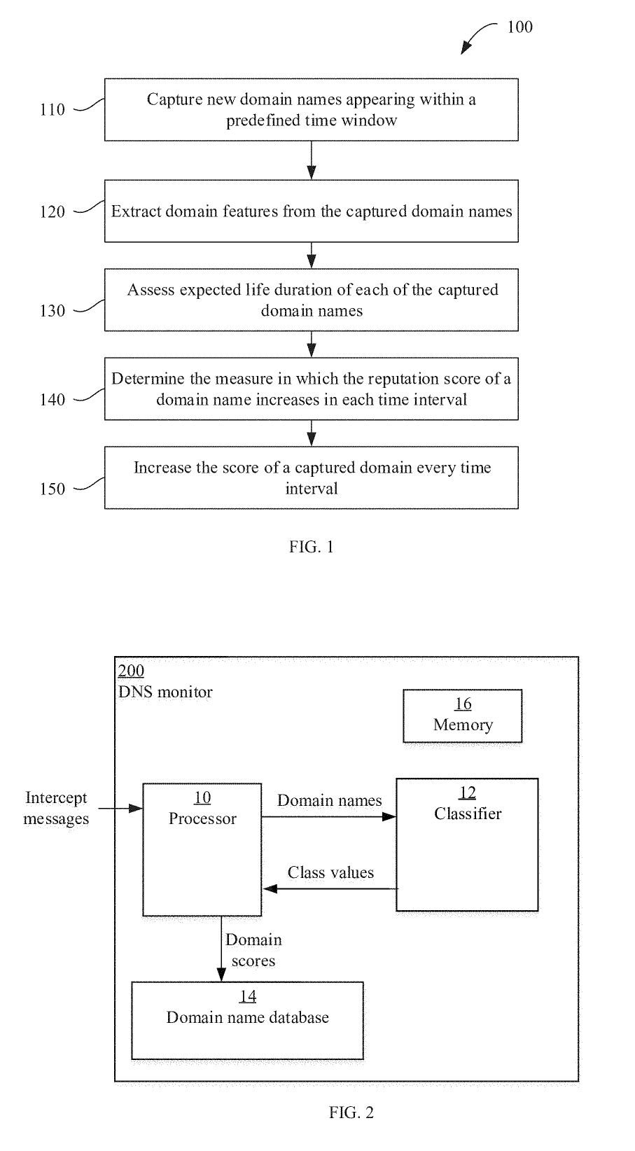

Reference is now made to FIG. 1, which is a schematic flowchart illustrating a method 100 for calculating and ascribing reputation scores for internet domain names, according to some embodiments of the present invention. Further reference is now made to FIG. 2, which is a schematic illustration of a Domain Name System (DNS) monitor system 200 according to some embodiments of the present invention.

The DNS monitor system 200 may include at least one processor 10, classifier 12, a domain name database 14 and a memory 16 for storing a code executable by at least one processor 10, for carrying out method 100. Processor 10 may execute and/or control a classifier 12 that may have machine learning abilities and may store updatable classification rules for classifying new domain names for assessing the expected life duration of each of the new domain names according to features of the domain names In some embodiments of the present invention, classifier 12 constitutes a code, for example stored in memory 16, including instructions for classification executable by processor 10. In some embodiments of the present invention, classifier 12 includes dedicated hardware.

Processor 10 feeds new domain names and/or their features to classifier 12 and/or trains and/or updates classifier 12 according to the new domain names and/or their features as described in more detail herein below, and to assess and re-assess credibility of captured domain names by the updated classifier.

As indicated in block 110, processor 10 may capture and/or communicate with and/or control a domain monitor server that captures new domain names appearing in a network within a predefined time window, denoted (t, t+c), of a duration c between time t and time t+c. For example, processor 10 intercepts by an agent in a network node or receives from a domain monitor server DNS messages such as requests and responses during the time window and identifying domain names in the intercepted requests and responses. New domain names are domain names that didn't appear within a previous time window. The captured domain names may be stored in database 14 along with corresponding reputation scores, determined and/or updated as described herein.

For each of the captured domain names, processor 10 may assign an initial reputation score. The reputation score of a captured domain name may increase in time, for example every predetermined time interval Ts, for example of about one second or a few seconds, in case the domain name is still active, as described in detail herein.

As indicated in block 120, processor 10 may extract features from the captured domain names such as, for example, top level domain (TLD), registrar, list of DNS record types, geographic location of hosting servers, geographic location of name servers, number of name servers, ASN details, similarity of parts of the domain name to popular brands, the length of the domain name and length of its tokens (separated by dot) and other features that may be derived from DNS requests and/or responses.

As indicated in block 130, based on the extracted features, classifier 12 may assess expected life duration of each of the captured domain names For example, classifier 12 may assess whether a captured domain name would remain reachable, i.e. active, after T seconds, or asses a probability that a captured domain name would remain reachable after T seconds. For example, processor 10 and/or classifier 12 may determine or may be configured with a series of N values of time Ti, wherein i goes from 1 to N and Ti₊₁ is longer than Ti. For each value Ti, classifier 12 may assess whether a captured domain name would remain reachable, i.e. active, after Ti seconds, or asses a probability Pi that a captured domain name would remain reachable after Ti seconds. Accordingly, classifier 12 may determine for a domain name a duration Td, which is the longest Ti after which the domain name would remain active, for example if an assessed probability Pd that the domain name would remain reachable after Td seconds is above a predetermined threshold.

Classifier 12 may ascribe to each captured domain name a class value, for example, according to the duration Td. For example, classifier 12 may ascribe a higher class value as the duration Td is longer.

The ascribed class value, and optionally the probability Pd, determine the increase measure of the reputation score of the domain name As indicated in block 140, processor 10 determines based on the ascribed class value and/or the probability Pd the measure in which the reputation score of a domain name increases in each time interval Ts. The reputation score increase measure is a function dependent on the class value and/or the probability Pd, such that the score increase is higher as the class value is higher and/or the probability Pd is higher. As indicated in block 150, processor 10 may increase the score of a captured domain name every time interval Ts by the determined reputation score increase measure.

After each update of classifier 12, the class value for a domain name may be calculated. For example, class values for domain names with low reputation scores may be recalculated. For example, class values domain names with reputation scores below a predetermined threshold may be recalculated. After each recalculation, processor 10 may decide based on the reputation score if a domain name should be identified as a malicious domain.

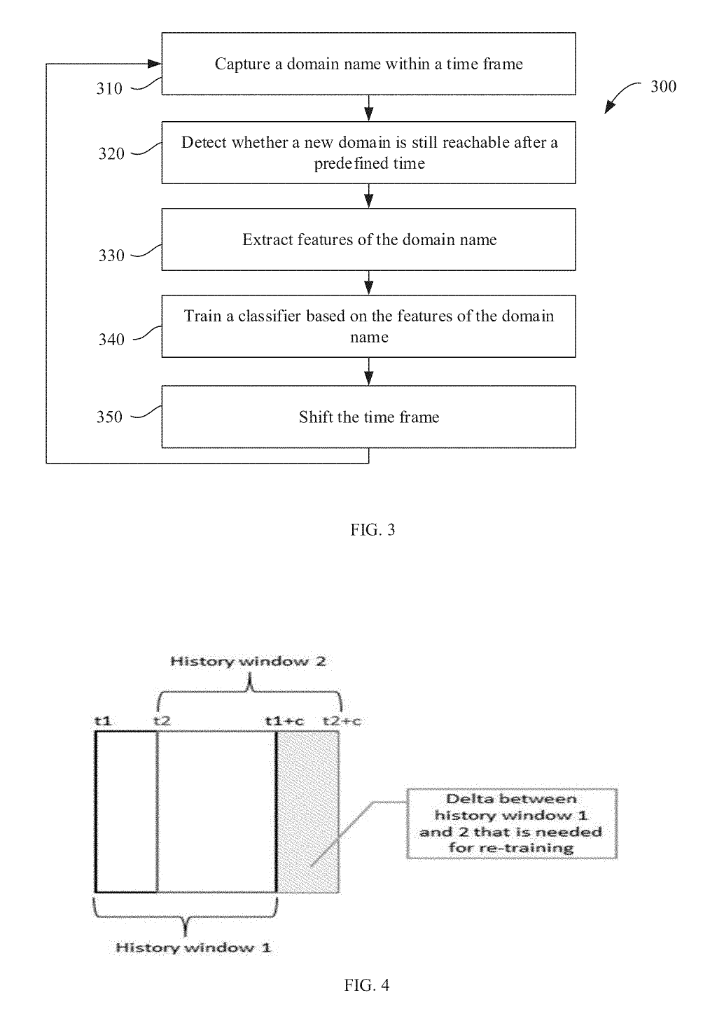

Reference is now made to FIG. 3, which is a schematic flowchart illustrating a method 300 for training classifier 12 for assessing expected life duration of new domain names, according to some embodiments of the present invention.

As indicated in block 310, processor 10 may capture new domain names appearing within a time frame (t, t+c). As indicated in block 320, processor 10 may detect whether a new captured domain name is still reachable, i.e. active, after Tc seconds.

For a domain name reachable after Tc seconds, as indicated in block 330, processor 10 may extract features of the domain name as described in detail herein. As indicated in block 340, processor 10 may train classifier 12 based on the features of the domain names that are still active after Tc seconds. For example, classifier 12 may be trained to identify the effect of each feature on whether a domain name would still be active after time Tc. For example, classifier 12 may be trained to identify the effect of each feature on decreasing or increasing the probability Pc that a domain name would still be active after time Tc. For example, similarity of parts of the domain name to popular brands may increase the probability Pc. For example, a long domain name may decrease the probability Pc.

For example, classifier 12 may be trained to attribute to each domain name, based on its extracted features, a class value reflecting the length of a time Td after which the domain name would still be active and/or the probability Pd that the domain name would remain active after time Td, by combining the effect of each of the extracted features on the time Td and/or the probability Pd.

For example, classifier 12 may be trained to map each domain name into a multi-dimensional space of features, wherein each feature affects the probability Tc of a domain name to remain active after Tc seconds, and/or calculate a class value based on the location of the domain name in the multi-dimensional space of features. In some embodiments of the present invention, classifier 12 may constitute of a weighted function of features, providing expected life duration of a domain name or a corresponding class value.

As indicated in block 350, the time frame (t, t+c) may be shifted, for example from (t₁, t₁+c) to (t₂, t₂+c), as shown in FIG. 4. Method 300 may be repeated periodically to update classifier 12, by periodically shifting the time frame and repeating the training of classifier. Thus, classifier 12 may be accommodated for changes in malicious domain patterns.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for calculating and ascribing reputation scores to Domain Name System (DNS) domain names, the system comprising:
a memory storing a code; and
at least one hardware processor coupled to the memory for executing the code, the code comprising:
instructions for capturing domain names appearing in a network during a predefined time frame and extracting features of each of the captured domain names; and
instructions for calculating a reputation score for each of the captured domain names by assessing an expected life duration of each of the captured domain names based on the domain name features.

2. The system according to claim 1, wherein the code further comprises instructions to intercept network messages during the predefined time frame and to capture domain names by identifying domain names in the intercepted messages.

3. The system according to claim 1, wherein the code further comprises instructions to assign an initial reputation score for each of the captured domain names, and instructions to increase the reputation score of a domain name every predetermined time interval in case the domain name is still reachable.

4. The system according to claim 3, wherein the instructions for calculating a reputation score include determining based on the life duration a measure in which the reputation score of a domain name increases in each time interval.

5. The system according to claim 4, wherein the determining is based on a probability that a captured domain name would remain reachable after a certain time period.

6. The system according to claim 1, wherein the domain name features include at least one of a list comprising top level domain (TLD), registrar, list of DNS record types, geographic location of hosting servers, geographic location of name servers, number of name servers, ASN details, similarity of parts of the domain name to popular brands, the length of the domain name and length of its tokens.

7. The system according to claim 1, wherein the code further comprises instructions for training a classifier to assess expected life duration of a domain name based on features of the domain name.

8. The system according to claim 7, wherein the classifier constitutes of a weighted function of domain name features.

9. The system according to claim 7, wherein the instructions for training a classifier to assess an expected life duration include at least one of instructions to train a classifier to assess whether a captured domain name would remain reachable after a certain time period and instructions to train a classifier to assess a probability that a captured domain name would remain reachable after a certain time period.

10. The system according to claim 9, wherein the certain time period is one of a predefined series of time period values, and wherein the instructions to train a classifier are for assessing the longest time period of the series of time period values after which the domain name would remain reachable.

11. The system according to claim 10, wherein the instructions to train a classifier are for determining a time period value of the series of time period values as the longest time period in case an assessed probability that the domain would remain reachable after the time period value is above a predetermined threshold.

12. The system according to claim 7, wherein the code comprises instructions for updating the classifier and repeating calculating of a reputation score once the classifier is updated.

13. The system according to claim 12, wherein the updating of the classifier includes shifting the time frame.

14. The system according to claim 12, wherein the calculation of reputation score is repeated for domain names having a reputation score below a predetermined threshold.

15. The system according to claim 7, wherein the training of a classifier comprises training the classifier to identify the effect of each domain name feature on whether a domain name would still be active after a predefined period of time.

16. The system according to claim 7, wherein the training of a classifier comprises training the classifier to calculate a class value reflecting the length of a time duration after which the domain name would still be active by combining the effect of each of the extracted features on the time duration.

17. The system according to claim 7, wherein the training of a classifier comprises training the classifier to map each domain name into a multi-dimensional space of features, wherein each feature affects the probability of a domain name to remain active after a predetermined time, and to calculate a class value based on the location of the domain name in the multi-dimensional space of features.

18. A method for calculating and ascribing reputation scores to DNS domain names, the method comprising:
capturing domain names appearing in a network during a predefined time frame and extracting features of each of the captured domain names; and
calculating a reputation score for each of the captured domain names by assessing an expected life duration of each of the captured domain names based on the domain name features.
